(19) United States
(12) Patent Application Publication
(10) Pub. No.: US 2015/0364853 A1
(43) Pub. Date: Dec. 17, 2015

(54) CONNECTOR ASSEMBLY, CONNECTOR BODY AND LIGHTING SYSTEM

(71) Applicant: KONINKLIJKE PHILIPS N.V., Eindhoven (NL)

(72) Inventors: Johannes Maria THIJSSEN, Best (NL); Andreas Aloysius Henricus DUIJMELINK, Aarle-Rixtel (NL); Noud Johannes FLEUREN, Baarlo (NL); Elena Tiziana FERRARI, Nuenen (NL); Matje MAESSEN, Helden (NL)

(73) Assignee: KONINKLIJKE PHILIPS N.V., Eindhoven (NL)

(21) Appl. No.: 14/764,374

(22) PCT Filed: Jan. 27, 2014
(86) PCT No.: PCT/IB2014/058575

§ 371 Date: Jul. 29, 2015

Related U.S. Application Data
(60) Provisional application No. 61/759,461, filed on Feb. 1, 2013.

(51) Int. Cl. H01R 13/502; H01R 4/30

(52) U.S. Cl. CPC H01R 13/502; H01R 4/30

(57) ABSTRACT

A connector assembly comprising at least a first connector body provided with a first mechanical interconnection element and a first connector part having at least one first conductor. The connector assembly further comprises a second connector body provided with a second mechanical interconnection element, a housing and a second connector part having at least one second conductor. The first and second connector bodies are releaseably connectable to each other by means of the mechanical interconnection elements, whilst the first and second conductors are releaseably connectable to each other. The second connector part is mounted on a slider being slideable with respect to the housing along a longitudinal axis thereof. The slider is slideable against spring force from a first position, wherein the slider is located near a front end of the second connector body to a second position at a distance of the front end. In the second position the second mechanical interconnection element is rotatable about the longitudinal axis with respect to the slider.

### FIELD OF THE INVENTION

The invention relates to connector assembly comprising at least a first connector body provided with a first mechanical interconnection element and a first connector part having at least one first conductor, the connector assembly further comprises a second connector body provided with a second mechanical interconnection element, a housing and a second connector part having at least one second conductor, which first and second connector bodies are releaseably connectable to each other by means of the mechanical interconnection elements, whilst the first and second conductors are releaseably connectable to each other.

The invention further relates to a connector body to be used in such a connector assembly.

The invention further relates to a lighting system comprising at least two interconnected modules.

### BACKGROUND OF THE INVENTION

Connector assemblies are in very widespread use in a multitude of fields. In the field of lighting equipment, connectors are used to connect lighting equipment to a power source to connect them amongst each other or to connect them to controls, such as sensors or switches. Since a lighting equipment can be located away from the power outlet or power source, a cable will be needed to connect the lighting equipment to the power outlet or power source. In general, a power cable may comprise two or more conductors for transporting the power from the power outlet towards the lighting equipment. Such a cable may also comprise data conductors.

US2004/0033711A1 shows a connector assembly, including a first connector body, and a rotating coupler rotatably secured to the first connector body having at least two securing members. A second connector body is also included, having at least two partially helical securing grooves formed about circumferential portions of an outer surface of the second connector body. Each of the helical securing grooves has an entry end and a terminal end. Upon assembly, the securing members enter an entry end of a respective securing groove and engage an upper axial surface thereof as the rotating coupler is rotated, and each securing member travels along the upper axial surfaces of the securing grooves toward the terminal ends thereof to securely couple the first and the second connector bodies to one another.

It is a disadvantage of this connector assembly that when the rotating coupler is rotated and the securing members travel along the surfaces of the securing grooves, a force in rotational direction is exerted onto both connector bodies, thus applying a torsion stress on a conductor mounted in the connector body. These torsion stresses can cause the conductor to become deteriorated or even to break. Furthermore, after clamping the whole second connector body cannot be rotated any longer with respect to the whole first connector body.

### SUMMARY OF THE INVENTION

In view of the above-mentioned and other drawbacks of the prior art, a general object of the present invention is to provide an improved connector assembly for creating a stable electrical and/or optical connection, and in particular a connector assembly that has conductors that are protected from being deteriorated by torsion stresses and a connector assembly that is easy to operate by an average user.

According to a first aspect, the invention provides a connector assembly wherein, the second connector part is mounted on a slider being slideable with respect to the housing along a longitudinal axis thereof, which slider is slideable against spring force from a first position wherein the slider is located near a front end of the second connector body to a second position at a distance of the front end, whilst in the second position the second mechanical interconnection element being rotatable about the longitudinal axis with respect to the slider.

When connecting the first and second connector bodies, the first and second connector parts are being moved towards each other to bring the conductors of both connector bodies in contact which each other. The first and second connector parts will be pressed against each other due to which the second connector part together with the slider will be slit against spring force in a direction parallel to the longitudinal axis of the housing and moved from the first position to the second position. The mechanical interconnection elements of both connector bodies will be interconnected to prevent against undesired decoupling of the connector bodies. The interconnection of the mechanical interconnection elements preferably takes places by at least a rotational movement between the two interconnection elements in the second position of the slider. During said rotational movement, the second mechanical interconnection element is free to rotate with respect to the slider together with the second connector part so that the second connector part will not be rotated with respect to the first connector part and no, or limited, torsion force will be applied on the connector parts and the cables connected thereto. The slider will maintain constantly at about the same rotational position with respect to the housing during said rotational movement.

When the first and second connector bodies are decoupled, the slider will be moved back from the second position to the first position by means of the spring force.

According to a further aspect, the invention provides a connector assembly wherein in the first position the slider and the second mechanical interconnection element are simultaneously rotatably with respect to the housing.

To this end for example a protrusion that is mounted on an inner circumferential wall of the second mechanical interconnection part is inserted into a longitudinally oriented groove part on an outer circumferential surface of the slider. Side walls of the longitudinally oriented groove allow the protrusion to move in the groove but prevent the protrusion to move in other directions. Therefore when rotating the second mechanical interconnection element, and thus the protrusion, the side walls of the longitudinally oriented groove forces the slider to rotate in the same direction as the second mechanical interconnection element.

It is especially advantageous that the housing can keep its orientation, i.e. the second mechanical interconnection element and the slider do rotate with regard to the housing that keeps its orientation. In case, for example, that the housing comprises transparent parts that are able to pass light beams, the orientation of the light beams will remain unchanged.

According to a further aspect, the invention provides a connector assembly wherein in the first position and between the first and second position the slider is locked against rotation with respect to the second mechanical interconnection element.

In this manner it is asserted that the slider and thus the second connector part has always the same orientation with respect to the second mechanical interconnection element so that both the second connector part as well as second mechanical interconnection element can always be easily be aligned and coupled to the corresponding parts on the first connector body.

According to a further aspect, the invention provides a connector assembly wherein the second connector body comprises at least one rotation stop limiting rotation between the slider and the housing up to 720 degrees, preferably up to 480 degrees.

On the one hand, such an angle needs to be large enough to enable the desired relative rotation of the slider and the housing with respect to each other but on the other hand needs to be small enough to prevent the cable to get damaged by too many rotations. When, for example, the housing is provided with a transparent part that allows light beams to pass, a user can adjust the path of the light beams by rotating the housing around its longitudinal axis over a desired angle.

Especially data connections are extremely vulnerable when the connection is deteriorated. Rotations over too large angles cause stresses in both the conductive material of the cable and the insulation material that surrounds the cables. These stresses lead to ruptures in the insulation material and allow formerly insulated conductive leads to interconnect and to short circuit.

According to a further aspect, the invention provides a connector assembly wherein each connector part comprises at least two conductors extending parallel to each other.

With at least two conductors extending parallel to each other no rotational movement between the two connector parts is possible when the connector parts are connected to each other. In such a case it is even more important to prevent torsion forces on the connector parts since such forces will easily cause breakage of the conductors, especially if the conductors are relatively thin fibers. Due to the slideable and rotatable slider torsion forces will be prevented.

According to a further aspect, the invention provides a connector assembly wherein the slider and second mechanical interconnection element comprise a longitudinal and circumferential groove-notch connection for the slideable and rotational movement respectively of the slider with respect to the second mechanical interconnection element.

Such a groove-notch connection can easily be manufactured and guarantees a reliable sliding and rotational movement.

According to a further aspect, the invention provides a connector assembly wherein the slider is slideable against spring force of a spring located between the slider and a spring wall, which spring wall is mounted in the housing.

Such a spring can easily be mounted inside the housing or the second mechanical interconnection element and will provide a desired spring force to be used to move the slider to the first position if the connector bodies are being decoupled.

According to a further aspect, the invention provides a connector assembly wherein the spring wall comprises a fixation element to fix a through-passing cable to the spring wall.

By means of the fixation element the cable extending from the second conductors and passing through the spring wall can be locked with respect to the spring wall. The cable located between the spring wall and the slider will be slightly twisted by the rotational movement of the slider with respect to the spring wall. However, the cable located on a side of the spring wall remote of the slider will not be twisted. The cable can be clipped into the fixation element, or fastened to the fixation element by all possible means to form a strain relief for the part of the cable located on a side of the spring wall remote of the slider.

According to a further aspect, the invention provides a connector assembly wherein the first and second interconnection elements form a bayonet-like connection.

Such a bayonet-like connection provides a connection which can easily be operated by first a translating movement followed by a rotating movement. Furthermore, such connection is reliable in locking the two connector bodies together.

According to a further aspect, the invention provides a connector assembly wherein at least one of the first and second connector bodies comprises a hinge.

Such a hinge makes it possible to let the first and second connector body pivot with respect to each other about a pivot axis extending perpendicular to the longitudinal axis.

The hinge may be comprised in the first and/or second connector body and may be formed by two formfitting parts, both formfitting parts having a contact area that is perpendicular to the pivot axis. Both contact areas face each other and can be in contact with each other in such a way that a friction force is provided between both faces to keep the hinge at a certain angle. The friction force may be applied by the torque of a screw holding the two faces together. The screw allows adjustment of the angle of the hinge.

The hinge may alternatively comprise two form fitting ball parts through which the cable or conductor is passed. An inner surface of the bigger ball part is allowed to slide over the outer surface of the smaller ball part in such a way that angles are allowed in a direction perpendicular to the longitudinal direction of the connector bodies. The inner surface of the bigger ball part and the outer surface of the smaller ball part can be in a formfitting connection. Within the hinge part, some excess cable is available to make up for the variation in length that is created when the hinge is bent. The movements of the ball parts with regard to each other are angularly limited in order not to damage the conductors or cables that are passed through.

According to a further aspect, the invention provides a connector assembly wherein a cable that passes through the at least one of the first and second connector body is curled up in the first and/or second connector body.

Such curled up part of the cable can easily take up torsion forces on the cable by being twisted, whereby the cable gets less or more curled. Preferably such curled up cable part is located between the slider and the spring wall of the embodiment as described above. Such a curled cable part mounted between the slider and the spring wall can easily make up for the translational and rotational movement of the slider with respect to the spring wall.

A curled cable has also the advantage of having the possibility to extend the length covered between two ends without getting damaged or deteriorated immediately. Whenever a connector body is extended the curled up cable has enough flexibility to make up for the difference in length.

According to a further aspect, the invention provides a connector assembly wherein the first and/or second connector body is extendable and/or retractable in a telescopical way to allow a variation in length of the respective connector body.

A connector body that is extendable or retractable in length has the advantage that the connector assembly itself can make up for play that unexpectedly may exist between two parts that need to be connected. When curling up the cable in the connector body, care should be taken to make sure that the maximum extension of the connector body does not damage the cable.

The invention further relates to a connector body to be used in a connector assembly, which connector body comprises a mechanical interconnection element, a housing and a connector part having at least one conductor, wherein the connector part is mounted on a slider being slideable with respect to the housing along a longitudinal axis thereof, which slider is slideable against spring force from a first position wherein the slider is located near a front end of the connector body to a second position at a distance of the front end, whilst in the second position the mechanical interconnection element being rotatable about the longitudinal axis with respect to the slider.

Such a connector body can easily be manufactured and can be easily coupled to another connector body provided preferably with a connector part that is not movable with respect to the mechanical interconnection element of said connector body.

The invention further relates to a lighting system comprising at least two interconnected modules, wherein each set of two interconnected modules being connected by a connector assembly according to the invention.

Both the first connector body and the second connector body can be mounted to a multitude of lighting equipment devices or other related lighting devices. The connectors can for example be directly fitted to a lighting device or module, thus becoming a part of the lighting device or module itself. The connector assembly can be mounted directly to the lighting equipment of a modular system, allowing the user to build a custom made lighting system using standardized modules. It is an advantage that the user can choose those lighting equipment elements that he needs for his specific lighting project. The use of the present connector assembly in a modular system has the advantage that the flexibility of the connector assembly allows rotation, bending and/or extension/retraction, so that the user can make up for any play in the system. The modular system may be a tubular system. A tubular form of the connector and the lighting equipment elements enhances the esthetical appearance of a lighting system as a whole, especially when the lighting equipment is also in tubular form with the same diameter as the connector assembly.

### BRIEF DESCRIPTION OF THE DRAWINGS

These and other aspects of the invention will now be described in more detail, with reference to the appended drawings showing currently preferred embodiments of the inventions, wherein:

FIGS. 1A and 1B show schematic views of an embodiment of the connector assembly according to the invention, wherein the connector bodies are decoupled;

FIG. 2 shows a longitudinal cross section view of the connector assembly as shown in FIGS. 1A and 1B;

FIG. 3 shows an exploded perspective view of the connector assembly as shown in FIGS. 1A and 1B;

FIGS. 4A and 4B show detailed views of the slider as shown in FIG. 3;

FIG. 5 shows a detailed view of a part of a second connector body of the connector assembly as shown in FIG. 3;

FIGS. 6A and 6B show an embodiment of a lighting system according to the invention.

FIGS. 7A and 7B show a second embodiment of a first connector body provided with a hinge; and

FIGS. 8A and 8B show a third embodiment of a first connector body that is expandable and retractable in a telescopical way.

### DESCRIPTION OF PREFERRED EMBODIMENTS

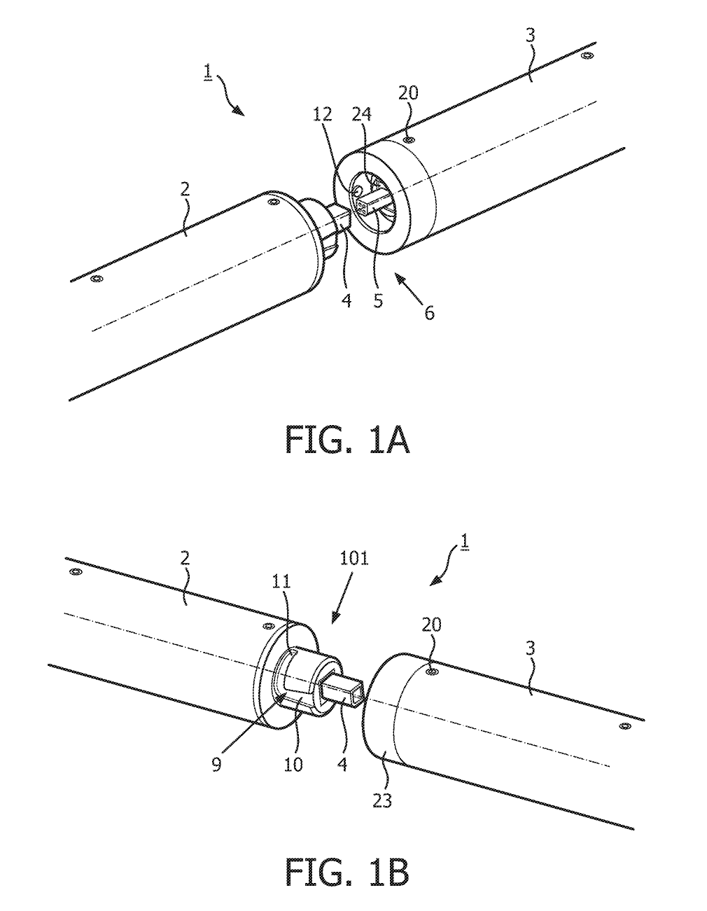

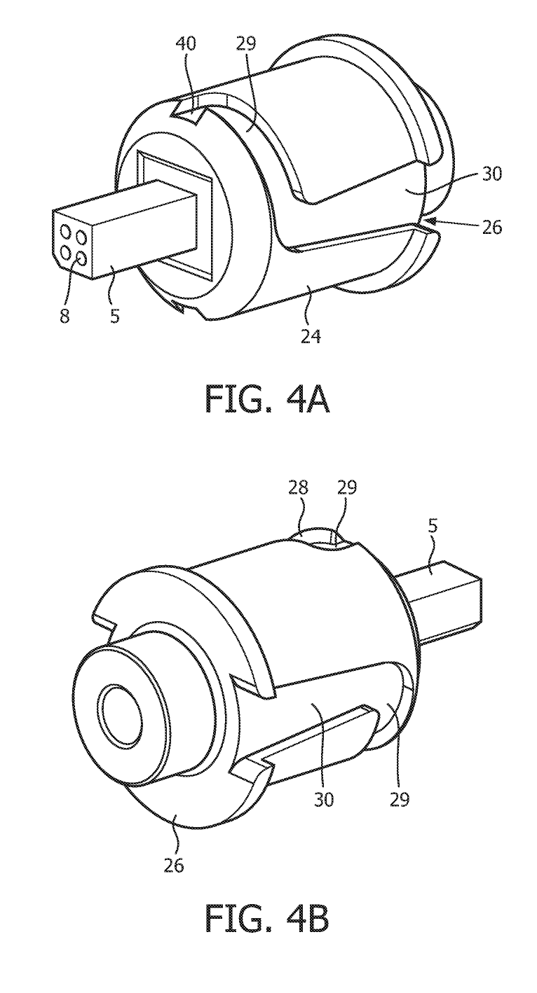

FIGS. 1A-5 show schematic views of an embodiment of the connector assembly 1. The connector assembly 1 comprises a first connector body 2 and a second connector body 3. The first connector body 2 comprises a first, male, connector part 4 that is connectable to a second, female, connector part 5 that is located near a front end 6 of the second connector body 3.

The first connector part 4 comprises four conductors 7 which are connectable to four electrical conductors 8 mounted on the second connector body 3. Two of the electrical conductors 7, 8 are for electrical power and two are for data addressing. When the electrical conductors 7 are connected to the electrical conductors 8, electrical power and data can be conducted from one connector body to the other connector body.

The first connector part 4 comprises a first mechanical interconnection element 101 formed by a groove 9. The groove 9 has a longitudinally oriented groove part 10 and an in circumferential direction oriented groove part 11 that is connected to the longitudinally oriented groove part 10. The groove 9 is located on an outer circumferential wall of the first connector part 4.

The second connector body 3 comprises a second mechanical connection element provided with a collar 23 and a knob 12 mounted on an inner circumferential wall of the collar 23. The diameter of the inner circumferential wall of the collar 23 is slightly larger than the outer diameter of the outer circumferential wall of the first connector part 4, which wall comprises the groove 9.

When mechanically interconnecting the first connector body 2 and the second connector body 3, the knob 12 is inserted into the longitudinally oriented groove part 10 and moved in longitudinal direction parallel to the longitudinal axis A. When the knob 12 has reached the end of the longitudinally oriented groove part 10, the knob 12 will be moved into the circumferential direction oriented groove part 11, whereby the knob 12 will be rotated about the longitudinal axis A until the end of the circumferential direction oriented groove part 11 is reached. Such a combination of a knob 12 being slideable in an L-shaped groove 9 is a mechanical connection which is called a bayonet mount.

The first connector body 2 comprises a housing 13 and a support part 14 being provided inside the first connector part 4. The housing 13 is made of a thin-walled material and is fixed to the support part 14 by means of at least one screw 15.

A cable 16 is located inside the housing 13 and an end of the cable 16 is connected to the electrical conductors 7.

The second connector body 3 comprises a thin-walled housing 17. In the thin-walled housing 17 a bearing 19 is securely fixed in a longitudinal direction by means of a screw 21. In rotational direction it allows 180 degrees rotation as will be explained here below. The second mechanical interconnection element 102 comprising the collar 23 and the knob 12, also comprises an inner sleeve 22 coaxially connected to the collar 23. The bearing 19 allows the second mechanical interconnection element 102 to be rotated with regard to the housing 17 of the second connector body 3. The angle of rotation that the inner sleeve 22 and its collar 23 of the second mechanical interconnection element 102 needs to make is at least the rotational angle that is needed to follow the circumferential groove part 11 on the first connector part 4 on the first connector body.

Near the collar 23 at the front end 6 of the second connector body 3, a slider 24 is slideably and rotatably mounted in the inner sleeve 22. The slider 24 is connected to the second connector part 5 with the four electric conductors 8.

The slider 24 is also provided with a cable passage 25 for passing through a cable 32 from the electric conductors 8 into the housing 17.

The side of the slider 24 facing away from the front end 6 comprises a support wall 26 for supporting a first end of a coil spring 27.

The slider 24 is also provided with a circumferentially outstanding ring 28, two circumferential grooves 29 located adjacent to the circumferentially outstanding ring 28 and two longitudinal grooves 30 provided on the circumferential area of the slider 24. Each longitudinal groove 30 extends from one of the circumferential grooves 29 in a direction parallel to the longitudinal axis A.

The inner sleeve 22 is provided with two notches 31 which can be aligned with the grooves 30 to enable the slider 24 to be translated with respect to the inner sleeve 22 as well as the housing 17 in a direction indicated by arrow P1 and opposite thereto. Furthermore, the notches 31 can be aligned with the circumferential grooves 29 to enable the slider 24 to be rotated with respect to the inner sleeve 22 as well as to the housing 17 about the longitudinal axis A. The grooves 29 are provided with openings 40. The openings 40 allow the slider 24 to be mounted within the inner sleeve 22 during the production process of the connector assembly 1.

Near the bearing 19 at a distance from the front end, a spring wall 34 is fixed to the thin-walled housing 17. The second end of the coil spring 27 is supported by the spring wall 34. The spring wall 34 comprises a tubular through going passage 35 for passing through the cable 32. Furthermore, the spring wall 34 comprises a fixation element 36 in order to fix the cable 32 with regard to the thin-walled housing 17. The cable on a side of the spring wall 34 adverse of the slider 24 will not be subject to translation or rotation when the slider 24 is being rotated or translated. The cable 32 is curved to make up for variations in length of the cable 32 and to enable rotation. The cable 32 is fixed to a LED-strip 33 that is mounted within the thin-walled housing 17 and that emits its light through a transparent part 56 in the thin-walled housing 17.

As the spring wall 34 is fixed to the thin-walled housing 17, the spring force that is exerted by the coil spring 27 forces the slider 24 in the direction as indicated by arrow P1 towards the front end 6 of the second connector body 3.

A thin-walled tubular spacer 37 is located between the housing 17 and the inner sleeve 22 and extends in the longitudinal direction between the bearing 19 and the collar 23. The thin-walled tubular spacer 37 is fixed to the thin-walled housing 17 by means of a screw 20. The screw 20 protrudes into a circumferential groove 18 that is provided on the outer surface of the inner sleeve 22 and extends all around over 360 degrees. The circumferential groove 18 extends all around, so it does not block any rotation of the thin-walled tubular spacer 37 but due to the screw 20, it only fixates the thin-walled tubular spacer 37 in longitudinal direction.

Furthermore, the inner sleeve 22 has a on the end opposite of the collar 23 a protruding part 60 that protrudes from the end of the inner sleeve 22 over a circumferential angle of approximately 60 degrees. The remaining 300 degrees in the circumferential direction form a path 61. The path 61 is limited in circumferential direction by two ends of the protruding part 60 that act as rotation stops.

Bearing 19 is provided with a pin 63 that protrudes from the inner circumferential surface of the bearing 19 inwardly. The bearing 19 is provided with an elongated opening 64 that extends in the circumferential direction of the bearing 19 over an angle of 180 degrees.

A screw 65 is used to fixate the cable in the spring wall 34, acting as a strain relief.

The pin 63 is movable in the circumferential direction along the path 61 between the rotation stops, thus allowing a rotation of the housing 17 with regard to the inner sleeve 22 over nearly 300 degrees. It is slightly less than the length of 300 degrees of the path 61, because the pin 63 has a thickness, which limits the path length about 5 degrees.

The screw 21 is moveable along the elongated opening 64 in the circumferential direction between a first end 66 of the elongated opening 64 and a second end 67 of the elongated opening 64 and vice versa, thus allowing a rotation of the housing 17 with regard to inner sleeve 22 over 180 degrees minus thickness of the screw 21.

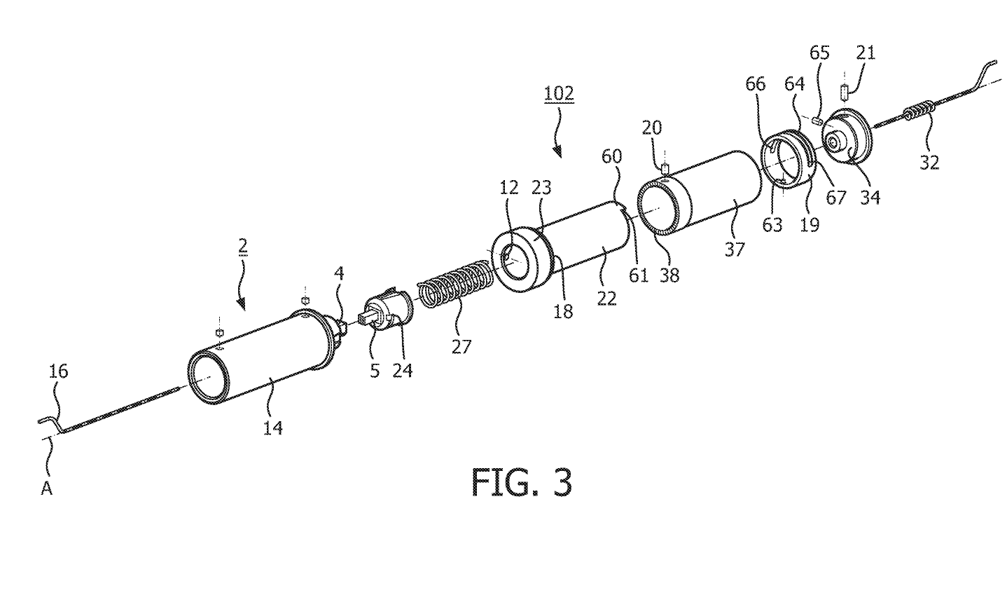

The present embodiment shown in for example FIG. 3 allows the housing to rotate with respect of the inner sleeve 22 over an angle of nearly 300 degrees and an additional angle of nearly 180 degrees. As these rotations are superposable, the resulting rotation of the housing 17 with respect to the inner sleeve 22 is nearly 480 degrees. It is noted that by amending the length of the path 61 and/or the elongated opening 64 the resulting rotation can be up to nearly 720 degrees.

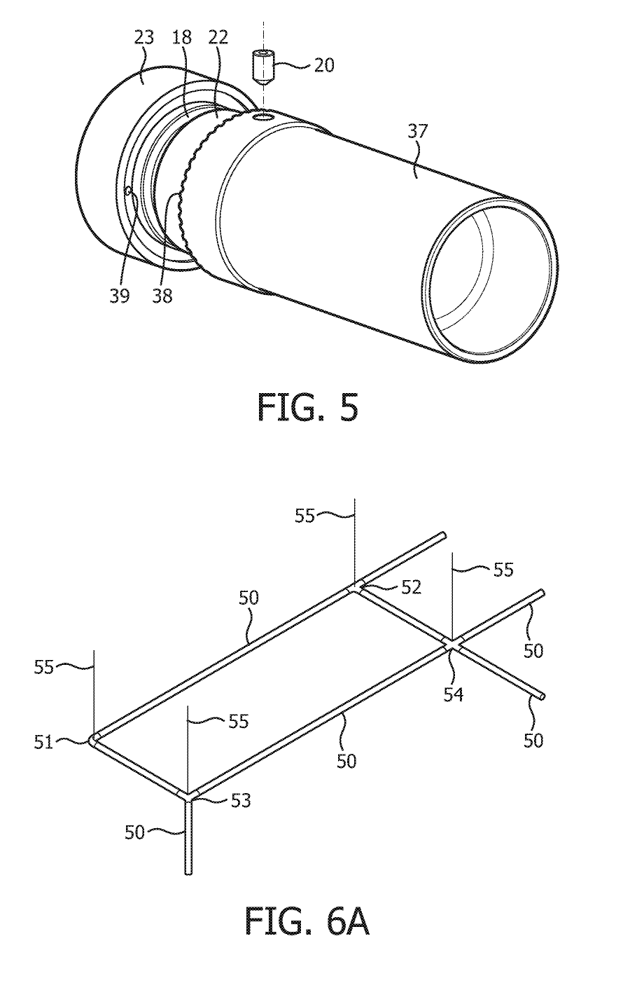

FIG. 5 shows a detailed view of the inner sleeve 22 with the collar 23 as well as the thin-walled tubular spacer 37 in which the inner sleeve 22 is rotatably located. The thin-walled tubular spacer 37 comprises on its side facing the collar 23 of the inner sleeve 22 a toothed circumferential area 38. The collar 23 comprises a spring pin 39 which can be inserted in one of the teeth of the circumferential area 38 thus allowing precise rotation of the housing 17 with respect to the collar 23 of the inner sleeve 22. The toothed circumferential area 38 can have for example 72 recesses, allowing the housing 17 to rotate in increments of 5 degrees with respect to the collar 23. The cooperation between the spring pin 39 and the toothed circumferential area causes a friction in the circumferential direction, thus making it more difficult for the user to rotate the thin-walled housing 17 with respect to the collar 23, but allowing the user to feel or hear a click when the spring pin 30 moves from one recess to another. The initial friction of the clicks forms a threshold that needs to be surpassed before a rotation can take place.

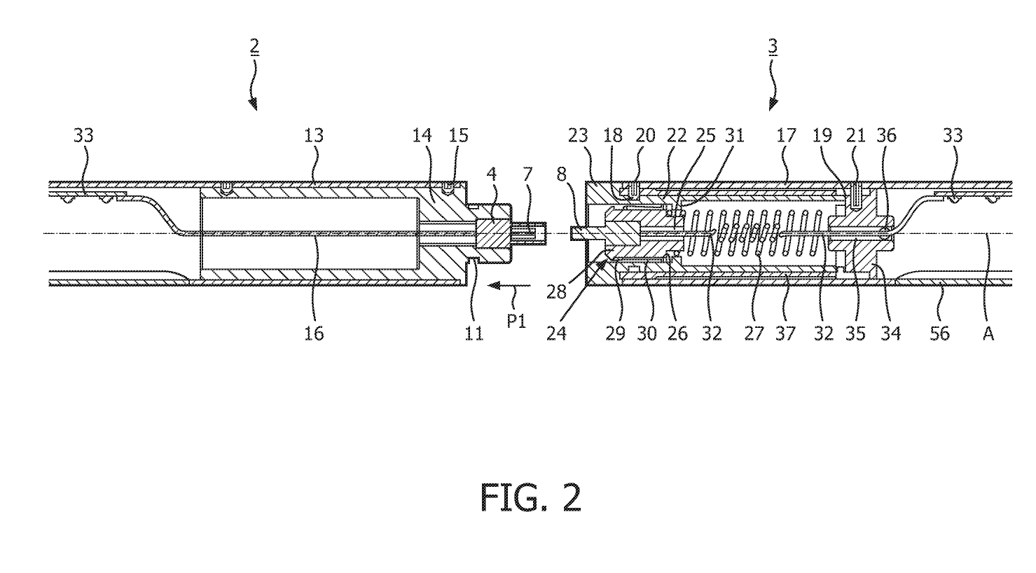

Before a connection between the first and second connector body 2, 3 is being made, the slider 24 is located in a first starting position as shown in FIG. 2. When the first and second connector body 2, 3 are connected to each other, the first male connector part 4 is moved towards and into the second female connector part 5, whereby an electrical connection is made between the electrical conductors 7, 8. During this translation the knob 12 of the inner sleeve 22 is guided into the groove part 10. During further movement of the knob 12 into the groove part 10, a pushing force is exerted by the first connector part 4 onto the second connector part 5. Due to this pushing force, the slider 24 with the second connector part 5 is being moved against spring force in a direction opposite to arrow P1, whereby the grooves 30 of the slider 24 are guided by the notches 31 on the inner sleeve 22. Since the notches 31 are located in the longitudinal grooves 30, no rotational movement of the slider 24 with respect to the inner sleeve 22 is possible.

At the moment that the knob 12 is located at the transition between the groove part 10 and the groove part 11, the slider 24 will be located in a second position, wherein the circumferential groove 29 of the slider 24 is located opposite the notches 31. The user will now rotate the collar 23 together with the inner sleeve 22 to move the knob 12 into the groove part 11, whereby the slider 24 and the second connector part 5 will remain in the same position with respect to the first connector part 4 of the first connector body 2. The inner sleeve 22 and the collar 23 will thus also be rotated with respect to the slider 24. The rotation will take place over the angle over which the groove part 11 extends, being for example 90 degrees.

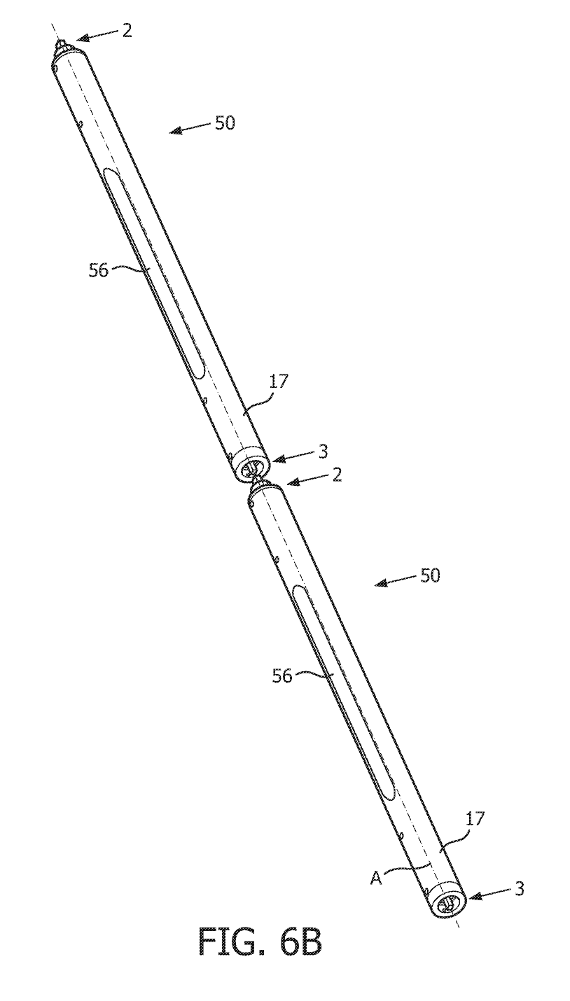

FIG. 6A shows a modular system of the connector assembly comprising a number of interconnected modules 50, 51, 52, 53, 54. Each module 50 comprises an elongated housing having a first connector body 2 on one end and a second connector body 3 at its opposite end. Each module 51 comprises a first connector body 2 and a second connector body 3 located at opposite sides, whereby the electrical conductors 7 extend perpendicular to the electrical conductors 8. When three modules 50 need to be connected together, the intermediate module 52 having a T-form is interposed between the modules 50. The T-shaped intermediate module 52 has either a first connector body 2 or a second connector body 3 at each of the three ends of the T-form. When four modules are connected together, a cross-shaped module 54 is provided having a first connector body 2 or a second connector body 3 at each of its four ends. To be able to let the elongated modules 50 extend in three directions, such as in a Y-form, a module 53 is provided with conductors at each of its three ends extending in three different directions. In such a way all kinds of connections can be made. Cables 55 are attached to the modules 51, 52, 53 54 in order for the modular system to be fixed to a ceiling of a building or the like.

FIG. 6B shows two modules 50 that are to be fixed together. To this end the modules 50 comprise the first connector body 2 and the second connector body 3 respectively. Each of the modules has in its thin-walled housing 17 the transparent part 56 opposite to the LED-strips 33. In a mounted position, a rotation of the thin-walled housing 17 around its longitudinal axis A allows a light beam from the LED-strips 33 that is emitted through the transparent part 56 to be rotated in a direction in the plane perpendicular to the longitudinal axis A.

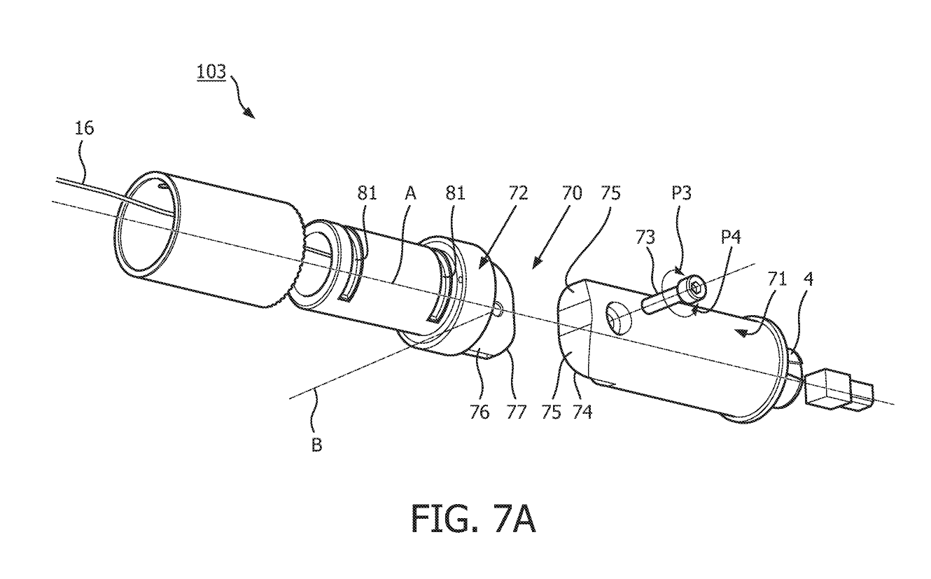

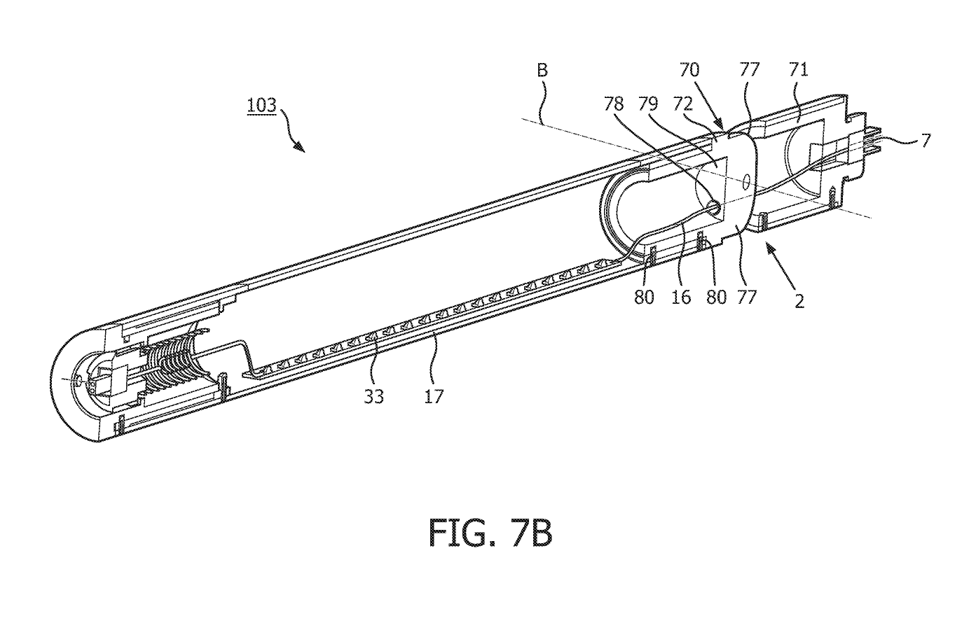

FIGS. 7A-7B show a second embodiment of a first connector body 103 provided with a hinge 70. The first connector body 103 differs from the first connector body 2 in that the first connector body 103 is provided with a hinge 70, in order to establish connections in different directions. The hinge 70 comprises a first hinge part 71 and a second hinge part 72. The first hinge part 71 and the second hinge part 72 are connected to each other by means of a screw 73. The center line of the screw 73 forms a rotation axis B. The rotation axis B extends perpendicular to the longitudinal axis A of the first connector body 2.

The first hinge part 71 of the first connector body 103 comprises a rotational sliding zone 74. The rotational sliding zone 74 is formed by a surface that is perpendicular to the rotation axis B. The extremity of the first hinge part 71 in the direction of the longitudinal axis A towards the second hinge part 72 has rounded edges 75.

The second hinge part 72 of the first connector body 2 comprises a rotational sliding zone 76 that is formed by a surface that is perpendicular to the rotation axis B and that is parallel to the rotational sliding zone 74 of the second hinge part 72. The extremity of the second hinge part 72 in the direction of the longitudinal axis A towards the first hinge part 71 has rounded edges 77.

The first hinge part 71 is rotatable with regard to the second hinge part 72 around the rotation axis B in the direction of arrows P3 or P4. The rotational sliding zone 74 of the first hinge part 71 and the rotational sliding zone 76 are facing each other. Both sliding zones 74, 76 can even be in contact with each other. In that case a friction exists between both sliding zones 74, 76. This friction can be varied by fastening or loosening the screw 73, as the friction force between both rotational sliding zones 74, 76 is dependent on the force or torque exerted by the screw pressing both rotational sliding zones 74, 76 together. Increasing the friction by fastening the screw 73 after adjusting the angle between the first hinge part 71 and the second hinge part 72 allows the angle to remain the same during the use period of the connector assembly.

FIG. 7B shows a longitudinal section view of the embodiment of FIG. 7A in which it is shown how the cable 16 is led through the hinge 70. The cable 16 is connected to the first conductor 7 on one end and to the LED-strip 33 on the other opposing end of the cable 16. A hole 78 for passing through the cable 16 is provided in a wall 79 that is placed on the end of the second hinge part 72 facing the first hinge part 71. Advantageously the hole 78 is placed near the rotation axis B, in order to prevent or to minimize bending and stretching of the cable 16. This bending or stretching could lead to wear of the cable 16.

It is noted that FIGS. 7A and 7B show a means for rotation the LED-strip 33 and its housing 17 around its longitudinal axis A. To this end the housing 17 comprises two screws 80 that protrude into grooves 81. The grooves 81 extend at least partially over the circumferential area of the second hinge part 72, in such a way that whenever the housing 17 is rotated with regard to the hinge 70 around the longitudinal axis A, the screws 80 follow within the grooves 81. In case that the grooves 81 extend only partially over the circumferential area of the second hinge part, the two ends of the grooves 81 form a mechanical rotation stop.

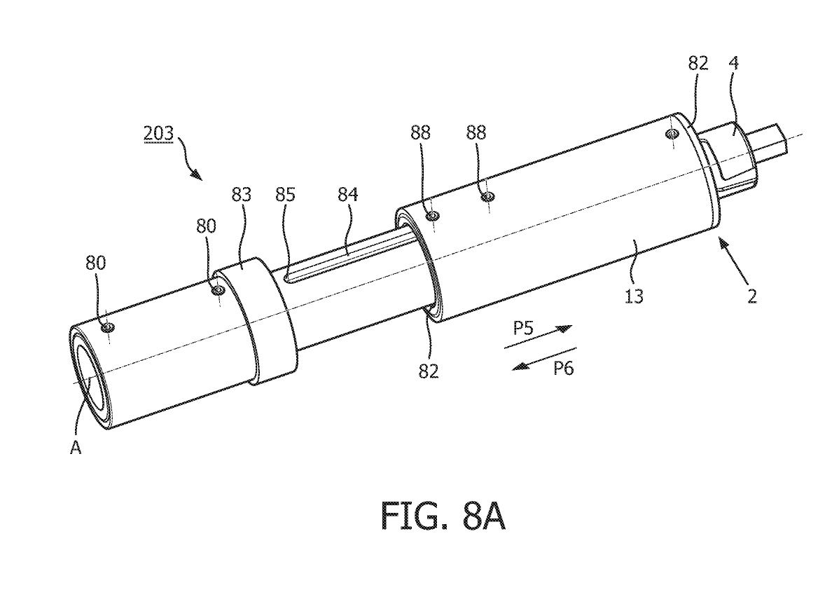

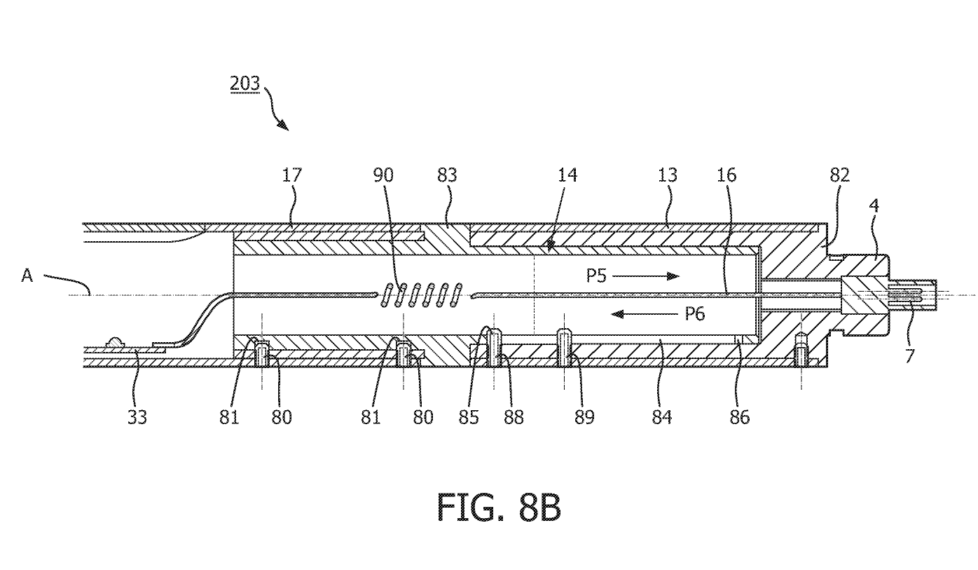

FIGS. 8A-8B show a third embodiment of a first connector body 203. The first connector body 203 differs from the first connector body 2 in that the first connector body 203 is provided with means to expand and retract the first connector body in such a way as to adapt 17 to a multitude of different lengths in a telescopical way.

To this end the support part 14 is provided in a two part form: a fixed part 83 that is fixed to the housing 17 and a movable part 82 that is movable with respect to the fixed part 83 in the direction of the longitudinal axis A.

The fixed part 83 comprises an elongated groove 84 that extends in the direction of the longitudinal axis A. The elongated groove 84 has two ends 85, 86, one on each longitudinal side of the elongated groove 84.

The movable part 82 is provided with the first connector part 4 on one side whilst the opposite other side has a hollow tube form, the inner diameter of the tube being just slightly bigger than the outer diameter of the fixed part 83. The movable part 82 comprises two screws 88, 89 that mount the housing 13 to the movable part 82 and that protrude through the elongated groove 84 of the fixed part 83. The movable part 82 is slideable in the longitudinal direction with respect to the fixed part 83.

In order for the cable 16 that connects the conductor 7 to the LED-strip 33 not to wear, deteriorate or to break, the cable 16 is provided with a coiled section 90 to make up for variations in length of the cable 16 due to retraction and expansion of the cable 16.

FIG. 8B shows the first connector body 203 in a retracted position. In the retracted position the screw 88 is placed against the end 85 of the elongated groove 84. The end 85 acts as an end stop for the screw 88.

In the expanded position the screw 88 is no longer in contact with the end 85 of the elongated groove 84. In the maximum extended position the screw 89 is in contact with the end 86 of the elongated groove 84, the end 86 forming an end stop for the screw 89. The system is very flexible as all the lengths between the retracted and maximum expanded position can be formed, by moving the movable part 82 in the direction of the arrow P5 when expanding and in the direction of the arrow P6 when retracting. The distance between the ends 85, 86 is bigger than the distance between the screws 88, 89, allowing both screws to move within the elongated groove 84.

The fixed part 83 is furthermore provided with two circumferential grooves 81 that extend at least partially over the circumferential area of the fixed part 83, in such a way that whenever the housing 17 is rotated with regard to the fixed part 83, the screws 80 follow within the grooves 81 in the same way as the first connector body 103.

The connectors for data addressing may also be optical fibers or any other kind of conductor.

It is also possible that the mechanical interconnection elements may comprise threads, so that the first connector body can be screwed onto the second connector body or vice versa. After the electrical connection has been established by connecting the electrical conductors of the two connector bodies, the mechanical connection can be established.

The person skilled in the art will realize that the present invention is by no means limited to the preferred embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the scope should not be construed as limiting the scope of the claims.

### LIST OF REFERENCE SIGNS

1 connector assembly
2 first connector body
3 second connector body
4 first connector part
5 second connector part
6 front end
7 conductor
8 conductor
9 groove
10 groove part
11 groove part
12 knob
13 housing
14 support part
15 screw
16 cable
17 housing
18 groove
19 bearing
20 screw
21 screw
22 inner sleeve
23 collar
24 slider
25 cable passage
26 support wall
27 coil spring
28 ring
29 groove
30 groove
31 notch
32 cable
33 LED-strip
34 spring wall
35 tubular passage
36 fixation element
37 tubular spacer
38 toothed circumferential area
39 spring pin
40 opening
50 module
51 module
52 module
53 module
54 module
55 cable
56 transparent part
60 protruding part
61 path
63 pin
64 opening
65 screw
66 first end
67 second end
70 hinge
71 first hinge part
72 second hinge part
73 screw
74 rotational sliding zone
75 edges
76 rotational sliding zone
77 edges
78 hole
79 wall
80 screw
81 groove
82 movable part
83 fix part
84 elongated groove
85 end
86 end
88 screw
89 screw
90 coiled section
101 first mechanical interconnection element
102 second mechanical interconnection element
103 first connector body
203 first connector body

1. A connector assembly comprising at least a first connector body provided with a first mechanical interconnection element and a first connector part having at least one first conductor, the connector assembly further comprises a second connector body provided with a second mechanical interconnection element a housing and a second connector part having at least one second conductor, which first and second connector bodies are releaseably connectable to each other by means of the mechanical interconnection elements, whilst the first and second conductors are releaseably connectable to each other, wherein, the second connector part (5) is mounted on a slider being slideable with respect to the housing along a longitudinal axis thereof, which slider is slideable against spring force of a spring from a first position wherein the slider is located near a front end of the second connector body to a second position at a distance of the front end, whilst in the second position the second mechanical interconnection element being rotatable about the longitudinal axis (A) with respect to the slider.

2. A connector assembly according to claim 1, wherein in the first position a protrusion mounted on an inner circumferential wall of the second mechanical element is inserted into a longitudinally oriented groove of an outer circumferential wall of the slider and wherein the second mechanical interconnection element and the slider are simultaneously rotatable in the same direction with respect to the housing.

3. A connector assembly according to claim 1, wherein in the first position and between the first and second position the slider is locked against rotation with respect to the second mechanical interconnection element.

4. A connector assembly according to claim 3, wherein the second connector body comprises at least one rotation stop limiting rotation between the slider and the housing up to 720 degrees.

5. A connector assembly according to claim 4, wherein each connector part comprises at least two conductors extending parallel to each other.

6. A connector assembly according to claim 5, wherein the slider and second mechanical interconnection element comprise a longitudinal and circumferential groove-notch connection for the slideable and rotational movement respectively of the slider with respect to the second mechanical interconnection element.

7. A connector assembly according to claim 6, wherein the spring is located between the slider and a spring wall, which spring wall is mounted in the housing.

8. A connector assembly according to claim 7, wherein the spring wall comprises a fixation element to fix a through-passing cable to the spring wall.

9. A connector assembly according to claim 8, wherein the first and second interconnection elements form a bayonet-like connection.

10. A connector assembly according to claim 9, wherein at least one of the first and second connector bodies comprises a hinge.

11. A connector assembly according to claim 10, wherein a cable that passes through the at least one of the first and second connector body is curled up in the first and/or second connector body.

12. A connector assembly according to claim 11, wherein the first and/or second connector body is extendable and/or retractable in a telescopical way to allow a variation in length of the respective connector body.

13. Connector body for use in a connector assembly according to claim 12, comprising a mechanical interconnection element, a housing and a connector part having at least one conductor, wherein the connector part is mounted on a slider being slideable with respect to the housing along a longitudinal axis (A) thereof, which slider is slideable against spring force of a spring from a first position wherein the slider is located near a front end of the connector body to a second position at a distance of the front end, whilst in the second position the mechanical interconnection element being rotatable about the longitudinal axis (A) with respect to the slider.

14. Lighting system comprising at least two electrically interconnected modules, each set of two interconnected modules being connected by a connector assembly according to claim 13.
